(19) United States
(12) Patent Application Publication
(10) Pub. No.: US 2019/0138931 A1
(43) Pub. Date: May 9, 2019

(54) APPARATUS AND METHOD OF INTRODUCING PROBABILITY AND UNCERTAINTY VIA ORDER STATISTICS TO UNSUPERVISED DATA CLASSIFICATION VIA CLUSTERING

(71) Applicant: SIOS Technology Corporation, Lexington, SC (US)

(72) Inventors: Sergey A. Razin, Columbia, SC (US); Tracy L. Marlatt, Lexington, SC (US)

(73) Assignee: SIOS Technology Corporation, Lexington, SC (US)

(21) Appl. No.: 16/134,545

(22) Filed: Sep. 18, 2018

Related U.S. Application Data
(60) Provisional application No. 62/561,404, filed on Sep. 21, 2017.

(51) Int. Cl. G06N 20/00; G06N 7/00; G06F 9/455

(52) U.S. Cl. CPC G06N 20/00; G06F 9/45558; G06N 7/005

(57) ABSTRACT

In a host device, a method for stabilizing a data training set comprises generating, by the host device, a data training set based upon a set of data elements received from a computer infrastructure; applying, by the host device, multiple iterations of a classification function to the data training set to generate a set of data element groups; dividing, by the host device, the set of data element groups resulting from the multiple iterations of the clustering function into multiple time intervals; for each time interval of the multiple time intervals, deriving, by the host device, a maximum threshold and a minimum threshold for each data element groups of the set of data element groups included in the time interval; applying an order statistic function to the maximum thresholds and the minimum thresholds for each time interval; and identifying a relative variability among the ordered maximum thresholds.

### RELATED APPLICATIONS

This patent application claims the benefit of U.S. Provisional Application No. 62/561,404, filed on Sep. 21, 2017, entitled, “Apparatus and Method of Introducing Probability and Uncertainty Via Order Statistics to Unsupervised Data Classification Via Clustering,” the contents and teachings of which are hereby incorporated by reference in their entirety.

### BACKGROUND

Enterprises utilize computer systems having a variety of components. For example, these conventional computer systems can include one or more servers and one or more storage devices interconnected by one or more communication devices, such as switches or routers. The servers can be configured to execute one or more virtual machines (VMs) during operation where each VM can be configured to execute or run one or more applications or workloads.

In certain cases, the computer systems can generate a large amount of data relating to various aspects of the infrastructure. For example, the computer systems can generate latency data related to the operation of associated VMs, storage devices, and communication devices. In turn the computer system can provide the data in real time to a host device for storage and/or processing.

### SUMMARY

As provided above, during operation the host device can receive real time data from the computer system and can retain and/or process the data. In order to identify particular patterns or trends of behavior of the computer system, the host device can be configured to utilize an unsupervised-machine learning function, such as a clustering function, to define a data training set. Further, the host device can utilize the data training set to derive the patterns of behavior of an environment in order to detect anomalous behavior or predict the future behavior for the computer system. For example, the host device can be configured to obtain the data that characterizes the workload and to define it as a training set that later is classified, or clustered, to derive the learned behavioral patterns of attributes of the computer system. The host device can also be configured to compare the learned behavioral pattern of the data training set to data elements of the received data to detect anomalous data elements, which are indicative of anomalous behavior within the computer system.

In the process of developing the training set, as a result of the clustering and re-clustering of the data elements over time, the host device executing the unsupervised-machine learning function can generate a relatively large amount of random variation in the clusters. This can be particularly true when the data elements received from the computer system, as used for the training set, have a lot of variability.

For example, FIG. 1 is a graph 5 that illustrates threshold variation among ten thresholds 2 associated with clusters 4 generated for one day's worth of average latency data for a given datastore. In this case, the clusters 4 underlying the thresholds 2 were generated by a host device configured to utilize one hundred clusters and one hundred iterations for convergence of an unsupervised-machine learning function, such as a clustering algorithm, applied by the host device. As indicated in FIG. 1, the greatest threshold variations tend to occur over time intervals where the underlying data exhibit a greater number of outliers and are, hence, themselves more variable. For example, a first time interval 6 provides a smaller variation among the thresholds 2-1 compared to the thresholds 2-2 of a second time interval 7. In such a case, the second time interval 7 includes a greater number of outliers relative to the first time interval 6.

As is indicated, application of the unsupervised machine learning function results in clusters having a wide range of variation. Anomalousness, however, is a function of the variability in the data, which is, in turn, reflected in the random variability among the thresholds. Accordingly, the resulting anomaly analysis and detection can give rise to unquantified uncertainty with respect to anomalous behavior detection within the computer system.

By contrast to conventional anomaly detection mechanisms, embodiments of the present innovation relate to an apparatus and method of introducing probability and uncertainty via order statistics to unsupervised data classification via clustering. In one arrangement, a host device is configured to limit variability and provide a level of certainty to an unsupervised machine learning paradigm utilized on data received from a computer infrastructure. For example, the host device can be configured to first execute a clustering function on a set of data elements received from a computer infrastructure over multiple iterations, such as for a total of ten iterations. Because of the inherent variation in the data element set, the host device can generate ten distinct sets of clusters. The host device can be further configured to then divide the resulting clusters among time slices and to find the maximum and minimum value threshold for each time slice. The host device can be further configured to then apply order statistics to the thresholds of each time slice and to assign a probability levels to each time slice. Quantification of the threshold variability provides a probabilistic framework which underlies anomaly detection.

Embodiments of the innovation enable the host device to quantify the uncertainty in the data training set. Specifically, the host device can be configured to stabilize the clustering of a data training set and to provide the measurement of the uncertainty or variation associated with the data training set. As a result, the host device can introduce probability estimation for various additional components associated with the computer infrastructure, such as anomaly detection, root cause selection, and/or issue severity ratings.

One embodiment of the innovation relates to, in a host device, a method for stabilizing a data training set. The method can comprise generating, by the host device, a data training set based upon a set of data elements received from a computer infrastructure; applying, by the host device, multiple iterations of a clustering function to the data training set to generate a set of clusters; dividing, by the host device, the set of clusters resulting from the multiple iterations of the clustering function into multiple time intervals; for each time interval of the multiple time intervals, deriving, by the host device, a maximum threshold and a minimum threshold for each cluster of the set of clusters included in the time interval; and applying, by the host device, an order statistic function to the maximum thresholds and the minimum thresholds for each time interval.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 is a graph that illustrates variation among ten thresholds associated with clusters generated out of ten clustering executions for one day's worth of average latency data for a given datastore, according to one arrangement.

FIG. 2 illustrates a schematic representation of a computer system, according to one arrangement.

FIG. 3 illustrates a schematic representation of the host device of FIG. 1, according to one arrangement.

FIG. 4 illustrates a graph showing the application of a clustering function to a data training set of FIG. 3, according to one arrangement.

FIG. 5 illustrates application of iterations of a clustering function to a data training set of FIG. 3, according to one arrangement.

FIG. 6 illustrates application of a time segmentation function to the clusters of FIG. 5, according to one arrangement.

FIG. 7 illustrates application of a threshold function to the each iteration of clusters of FIG. 6, according to one arrangement.

FIG. 8 illustrates application of an ordering function to the threshold functions of FIG. 6, according to one arrangement.

FIG. 9 illustrates application of an ordering function to the threshold functions of FIG. 6, according to one arrangement.

### DETAILED DESCRIPTION

Embodiments of the present innovation relate to an apparatus and method of introducing probability and uncertainty via order statistics to unsupervised data classification via clustering. In one arrangement, a host device is configured to limit variability and provide a level of certainty to an unsupervised machine learning paradigm utilized on data received from a computer infrastructure. For example, the host device can be configured to first execute a clustering function on a set of data elements received from a computer infrastructure over multiple iterations, such as for a total of ten iterations. Because of the inherent variation in the data element set, the host device can generate ten distinct sets of clusters. The host device can be configured to then divide the resulting clusters among time slices and to find the maximum and minimum value threshold for each time slice. The host device can be configured to then apply order statistics to the thresholds of each time slice and to assign a probability levels to each time slice. Quantification of the threshold variability provides a probabilistic framework which underlies anomaly detection as well as other functions that can be derived from behavioral analysis, such as forecasting of the future behavior.

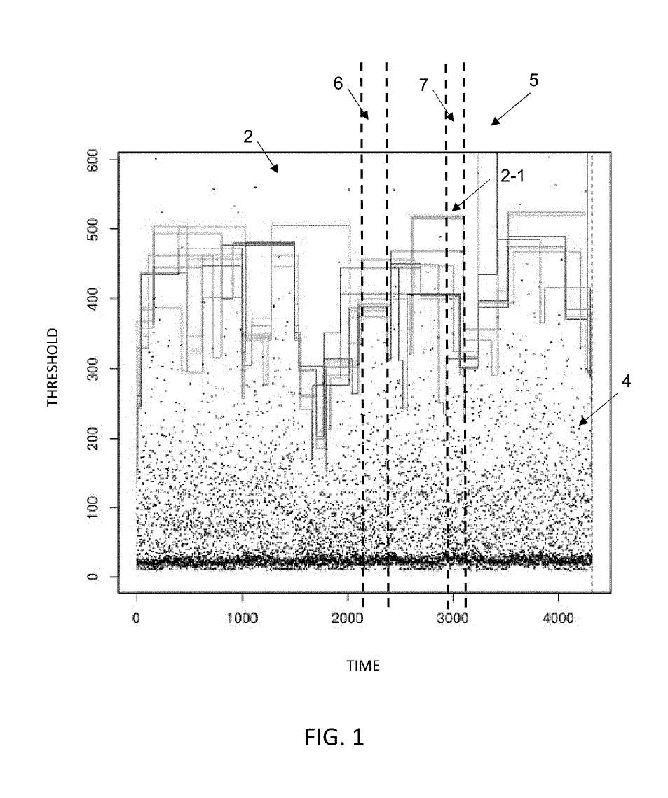

FIG. 1 illustrates an arrangement of a computer system 10 which includes at least one computer infrastructure 11 disposed in electrical communication with a host device 25. While the computer infrastructure 11 can be configured in a variety of ways, in one arrangement, the computer infrastructure 11 includes computer environment resources 12. For example, the computer environment resources 12 can include one or more server devices 14, such as computerized devices, one or more network communication devices 16, such as switches or routers, and one or more storage devices 18, such as disk drives or flash drives.

Each server device 14 can include a controller or compute hardware 20, such as a memory and processor. For example, server device 14-1 includes controller 20-1 while server device 14-N includes controller 20-N. Each controller 20 can be configured to execute one or more virtual machines 22 with each virtual machine (VM) 22 being further configured to execute or run one or more applications or workloads 23. For example, controller 20-1 can execute a first virtual machine 22-1 which is configured to execute a first set of workloads 23-1 and a second virtual machine 22-2 which is configured to execute a second set of workloads 23-2. Each compute hardware element 20, storage device element 18, network communication device element 16, and application 23 relates to an attribute of the computer infrastructure 11.

In one arrangement, the host device 25 is configured as a computerized device having a controller 26, such as a memory and a processor. The host device 25 is disposed in electrical communication with the computer infrastructure 11 and with a display 51. The host device 25 is configured to receive, via a communications port (not shown), a set of data elements 24 from at least one computer environment resources 12 of the computer infrastructure 11 where each data element 28 of the set of data elements 24 relates to an attribute of the computer environment resources 12. For example, each data element 28 can relate to the compute level (compute attributes), the network level (network attributes), the storage level (storage attributes) and/or the application or workload level (application attributes) of the computer environment resources 12. Also, each data element 28 can include additional information relating to the computer infrastructure 11, such as events, statistics, and the configuration of the computer infrastructure 11. As a result, the host device 25 can receive data elements 28 that relate to the controller configuration and utilization of the servers devices 14 (i.e., compute attribute), the virtual machine activity in each of the server devices 14 (i.e., application attribute) and the current state and historical data associated with the computer infrastructure 11.

Each data element 28 of the set of data elements 24 can be configured in a variety of ways. In one arrangement, each data element 28 can include object data that can identify a related attribute of the originating computer environment resource 12. For example, the object data can identify the data element 28 as being associated with a compute attribute, storage attribute, network attribute, or application attribute of a corresponding computer environment resource 12. In one arrangement, each data element 28 can include statistical data that can specify a behavior associated with the computer environment resource 12.

In one arrangement, the host device 25 can include a machine learning analytics framework or engine 27 configured to receive each data element 28 from the computer infrastructure 11, such as via a streaming API, and to automate analysis of the data elements 28 during operation. For example, as will be described below, when executing the machine learning analytics engine 27, the host device 25 is configured to transform, store, and analyze the data elements 28 over time. Based upon the receipt of the of data elements 28, the host device 25 can provide continuous analysis of the computer infrastructure 11 in order to identify anomalies associated with attributes of the computer infrastructure 11 on a substantially continuous basis. Further, the host device 25 can perform other functions based upon the receipt of the of data elements 28. These functions can include, but are not limited, to forecasting of the future behaviors and operational issues associated with the computer infrastructure 11.

The controller 26 of the host device 25 can be configured to store an application of the machine learning analytics engine 27. For example, the machine learning analytics engine application installs on the controller 26 from a computer program product 32. In some arrangements, the computer program product 32 is available in a standard off-the-shelf form such as a shrink wrap package (e.g., CD-ROMs, diskettes, tapes, etc.). In other arrangements, the computer program product 32 is available in a different form, such downloadable online media. When performed on the controller 26 of the host device 25, the machine learning analytics engine application causes the host device 25 to perform the classification, or clustering, stabilization on a data training set and to detect operational uncertainty. As a result of the classification and detection, the host device can provide an output 52 to a user via a graphical user interface 50 as provided by the display 51.

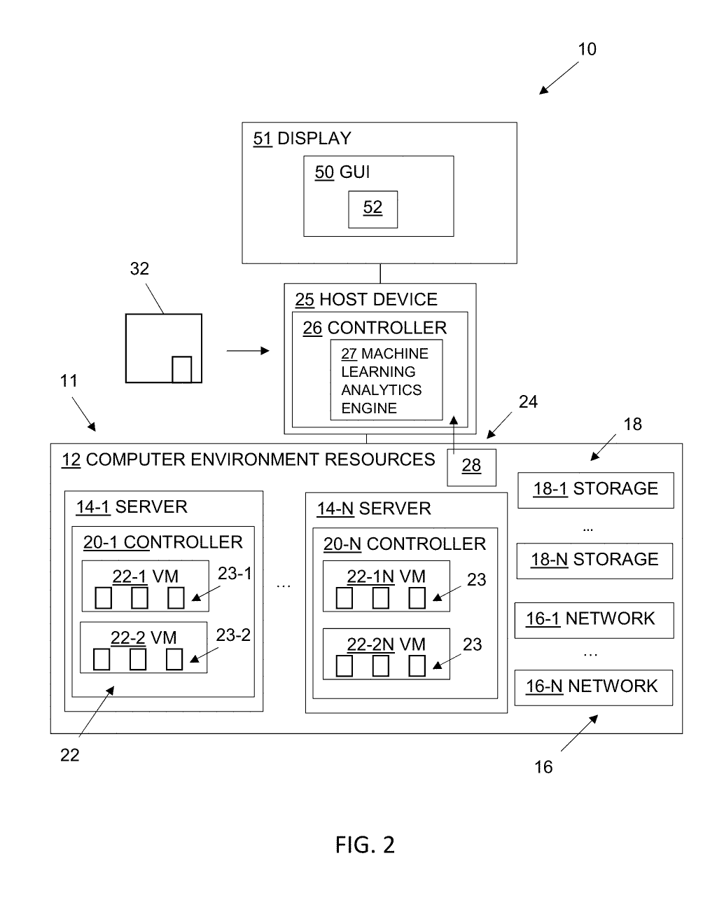

FIG. 2 is a schematic diagram of the host device 25 showing an example method performed by the host device 25 when executing the machine learning analytics engine 27 to perform classification, or clustering, stabilization on a data training set as well as detection of operational uncertainty.

During operation, the host device 25 is configured to collect data elements 28, such as latency information (e.g., input/output (IO) latency, input/output operations per second (IOPS) latency, etc.) regarding the computer environment resources 12 of the computer infrastructure 11. For example, the host device 25 is configured to poll the computer environment resources 12, such as via private API calls, to obtain data elements 28 relating to latency within the computer infrastructure 11.

In one arrangement, as the host device 25 receives the data elements 28, the host device 25 is configured to direct the data elements 28 to a uniformity or normalization function 34 to normalize the data elements 28. For example, any number of the computer environment resources 12 can provide the data elements 28 to the host device 25 in a proprietary format. In such a case, the normalization function 34 of the host device 25 is configured to normalize the data elements 28 to a standard, non-proprietary format.

In another case, as the host device 25 receives the data elements 28 over time, the data elements 28 can be presented with a variety of time scales. For example, for data elements 28 received from multiple network devices 16 of the computer infrastructure 11, the latency of the devices 16 can be presented in seconds (s) or milliseconds (ms). In this example, the normalization function 34 of the host device 25 is configured to format the data elements 28 to a common time scale. As will be described below, normalization of the data elements 28 for application of a clustering function provides equal scale for all data elements 28 and a balanced impact on a distance metric utilized by the clustering function (e.g., a Euclidean distance metric). Moreover, in practice, normalization of the data elements 28 tends to produce clusters that appear to be roughly spherical, a generally desirable trait for cluster-based analysis.

Next, the host device 25 is configured to develop a data training set 36 for use in anomalous behavior detection. In one arrangement, the host device 25 is configured to store normalized data elements 30 as part of the data training set 36 which can then be used by the host device 25 to detect the anomalous behavior within the computer infrastructure 11. For example, the host device 25 can include, as part of data training set 36, normalized latency data elements 30 having per object (i.e., datastore) sampling, such as 5 minute average interval, normalized to each day of the week as an index (e.g., Sunday 0:00 is 0, Monday 0:00 is 300 . . . 0-2100 for a week, Monday-Sunday, for the 5 minute averaged data). As such, the data training set 36 can include data collected over a timeframe of a day, week, or month. Further, the host device 25 can be configured to update the data training set 36 at regular intervals, such as during daily intervals. For example, the data training set 36 can further contain 10,000 samples per object (˜1 month worth of performance data) which can be refreshed on daily basis.

In one arrangement, after collecting a given volume of normalized data elements 30 as part of the data training set 36, (e.g., normalized data elements 30 collected over a period of seven days) the host device 25 is configured to stabilize various characteristics of the data training set 36 for use in anomaly detection. For example, an anomaly is an event that is considered out of ordinary (e.g., an outlier) based on the continuing analysis of data with reference to the historical or data training set 36 and based on the application of the principles of machine learning.

In one arrangement, in stabilizing the characteristics of the data training set 36, the host device 25 is configured to apply multiple iterations of a classification function 38 to the data training set 36. For example, the host device 25 includes a classification function 38 which, when applied to the normalized latency data elements 30 (i.e., the attribute of the computer infrastructure resources of the computer infrastructure) of the data training set 36, is configured to define at least one group of the data elements 30 (i.e., data element groups).

While the classification function 38 can be configured in a variety of ways, in one arrangement, the classification function 38 is configured as an unsupervised machine learning function, such as a clustering function 40, that defines the data element groups as clusters. Clustering is the task of grouping a set of objects in such a way that objects in the same group, called a cluster, are more similar to each other than to the objects in other groups or clusters. Clustering is a common technique of machine learning data analysis, used in many fields, including pattern recognition, image analysis, information retrieval, and bioinformatics. The grouping of objects into clusters can be achieved by various algorithms that differ significantly in their notion of what constitutes a cluster and how to efficiently find them. Known clustering algorithms include hierarchical clustering, centroid-based clustering (i.e., K-Means Clustering), distribution based clustering, and density based clustering.

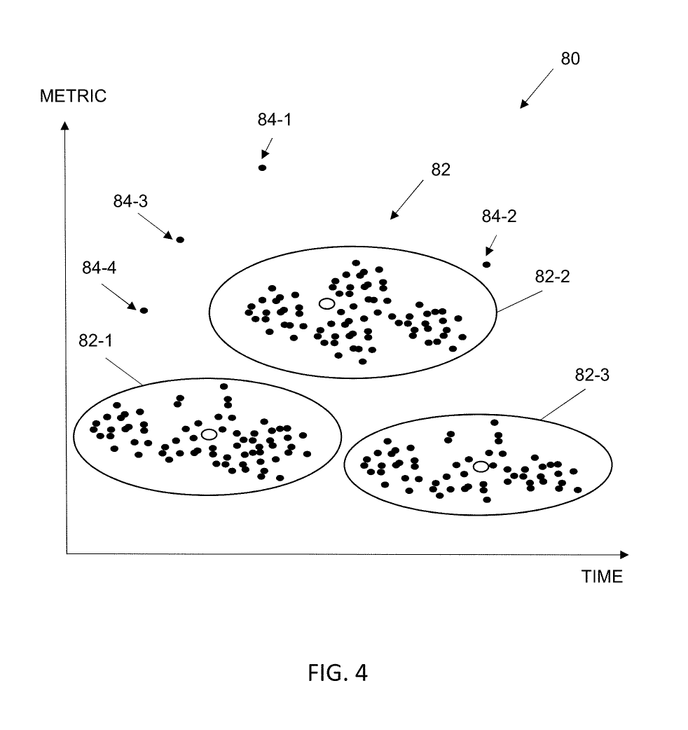

In one arrangement, during each application of the clustering function 40 to the data training set 36, the host device 25 separates the information of the data training set 36 into sets of clusters. For example, FIG. 4 illustrates a graph 80 showing an application of the clustering function 40 to the data training set 36. Application of the clustering function 40 by the host device 25 results in the generation of sets of clusters 82 such as first, second, and third clusters 82-1, 82-2, and 82-3, where each cluster 82-1 through 82-3 identifies computer infrastructure attributes (e.g., input/output (IO) latency, input/output operations per second (IOPS) latency, etc.) having some common similarity. Application of the clustering function 40 by the host device 25 also can identify outlying or non-clustered information elements 84-1 through 84-4 and treat these outlying elements 84-1 through 84-4 as noise in the data.

By applying the clustering function 40 to the data training set 36, the host device 25 can derive learned behaviors of the various attributes of the computer infrastructure 11. However, variability of the data training set 36 can result in variability in the clusters generated following application of the clustering function 40. For example, application of the clustering function 40 to the data training set 36 in a first iteration can result in the generation of a first set of clusters which identify computer infrastructure attributes having some common similarity. However, application of the clustering function 40 to the data training set 36 in subsequent iterations can typically generate slightly or very different clustering results. That is, application of the clustering function 40 to the data training set 36 in a second iteration can result in the generation of a second set of clusters that are different from the first set of clusters and the application of the clustering function 40 to the data training set 36 in a third iteration can result in the generation of a third set of clusters that are different from the first set of clusters and from the second set of clusters. This can lead to instability of the model of the learned behavior of the computer structure attributes.

In order to develop a set of stabilized characteristics from the data training set 36, the host device 25 is configured to apply the clustering function 40 to the data training set 36 over multiple iterations and to derive the learned behavior of the computer infrastructure based upon the results of the iterative application of the clustering function 40.

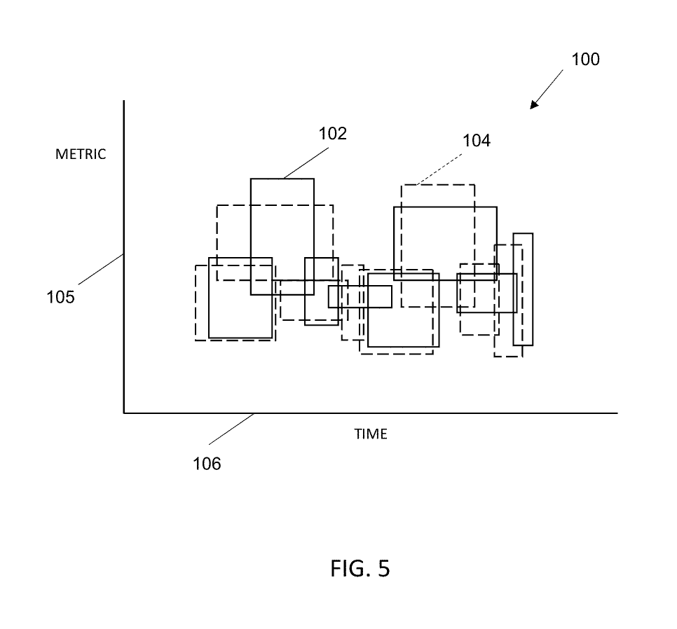

In one arrangement, with reference to FIG. 5, the host device 25 is configured to apply the clustering function 40 to the data training set 36 associated with a given metric, such as latency, and for a given number of iterations. For example, the host device 25 can be configured to apply the clustering function 40 to the data training set 36 for a total of ten iterations. FIG. 5 is a metric-time graph 100 that illustrates a schematic representation of a first set of clusters 102 resulting from a first application of the clustering function 40 to the data training set 36 and a second set of clusters 104 resulting from a second application of the clustering function 40 to the data training set 36. The clustering results for only two of the ten iterations is shown for clarity. It is noted that while the host device 25 can apply the clustering function 40 to the data training set 36 for a total of ten iteration, in one arrangement, the host device 25 can be configured to apply the clustering function 40 to the data training set 36 either more than or less than ten iterations.

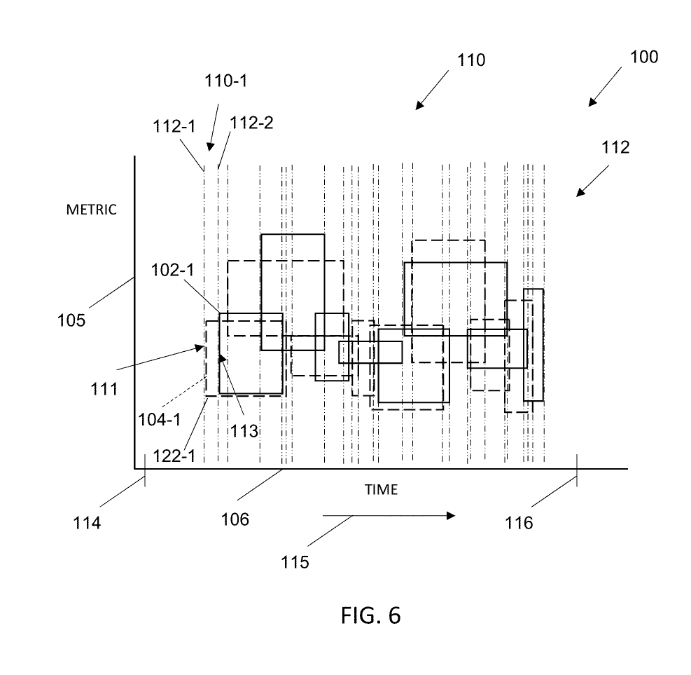

Next, the host device 25 is configured to derive the learned behavior from the sets of clusters generated from the data training set 36. In one arrangement, with reference to FIG. 6, the host device 25 is configured to divide the clusters resulting from the iterations of the clustering function 40 into multiple time intervals 110 or multiple learned behaviors. The host device 25 can be configured to detect first and second time edges (e.g., left and right edges) associated with each cluster and to assign corresponding time interval boundaries 112 to each time edge. For example, as the host device 25 identifies metric values along a time axis 106 of the metric-time relationship from a first time 114 to a second time 116, the host device 25 can be configured to identify either one of, or both, consecutively increasing and decreasing metric values along a metric axis 105 at a given time value. Such consecutively increasing and/or decreasing metric values are indicative of the presence of a time edge associated with a cluster. Sequentially disposed time interval boundaries 112 of each cluster define a given time interval 110.

During operation, with continued reference to FIG. 6, based on a review of the sets of clusters 102, 104 relative to a time axis 106 of the metric-time graph 100, the host device 25 can detect a first (e.g., left) time edge 111 of a first cluster 104-1 of the second set of clusters 104 as being associated with the earliest occurrence of any time edge of any cluster. As a result of such detection, the host device 25 can assign the first time edge 111 of the first cluster 104-1 a first time interval boundary 112-1. As the host device 25 progresses though the set of clusters along the time axis and along direction 115, the host device 25 can detect a first time (e.g., left) edge 113 of a first cluster 102-1 of the first set of clusters 102 as being associated with the next subsequent time edge of a cluster. As a result of such detection, the host device 25 can assign the first time edge 113 of the first cluster 102-1 a second time interval boundary 112-2. The first and second time interval boundaries 112-1, 112-2 define a first time interval 110-1. As the host device 25 continues to progress through the set of clusters along direction 115, the host device 25 is configured to continue identify time edges and corresponding time interval boundaries 122 and to define successive time intervals 110 associated with the sets of clusters 102, 104. Each of the time intervals 110 represents an underlying behavior of a given metric, such as latency, of the computer infrastructure 11.

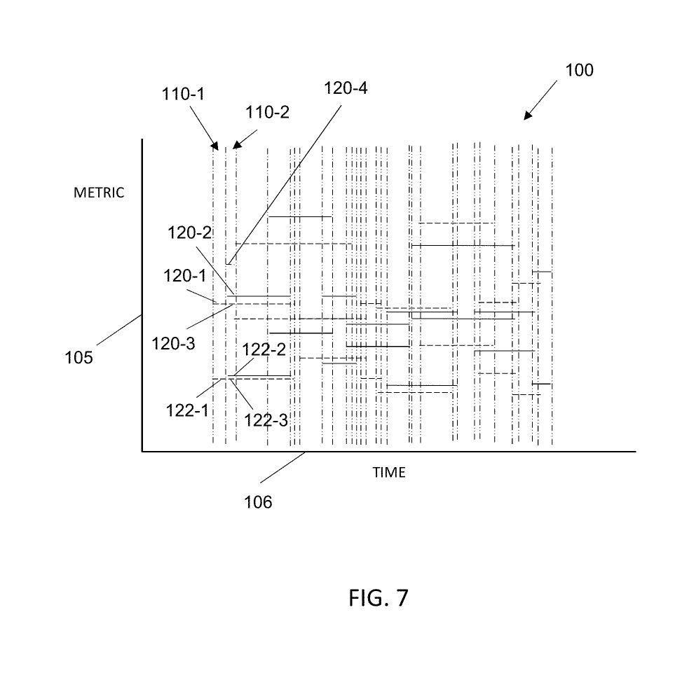

Next, the host device 25 is configured to detect the maximum and minimum threshold for each cluster of each clustering function iteration associated with each time interval 110. For example, with reference to FIG. 7, the host device 25 is configured to review each time interval 110 to identify all thresholds, both maximum thresholds 120 and minimum thresholds 122 associated with that time interval 110. For example, based upon a review of the first time interval 110-1 the host device can identify a first maximum threshold 120-1 and a first minimum threshold 122-1 associated with the first cluster 104-1 of the second set of clusters 104. Further, based upon a review of the second time interval 110-2, the host device 25 can identify a first maximum threshold 120-2 and a first minimum threshold 122-2 associated with the first cluster 102-1 of the first set of clusters 102, and can identify a second maximum threshold 120-3 and a second minimum threshold 122-3 associated with the first cluster 104-1 of the second set of clusters 104.

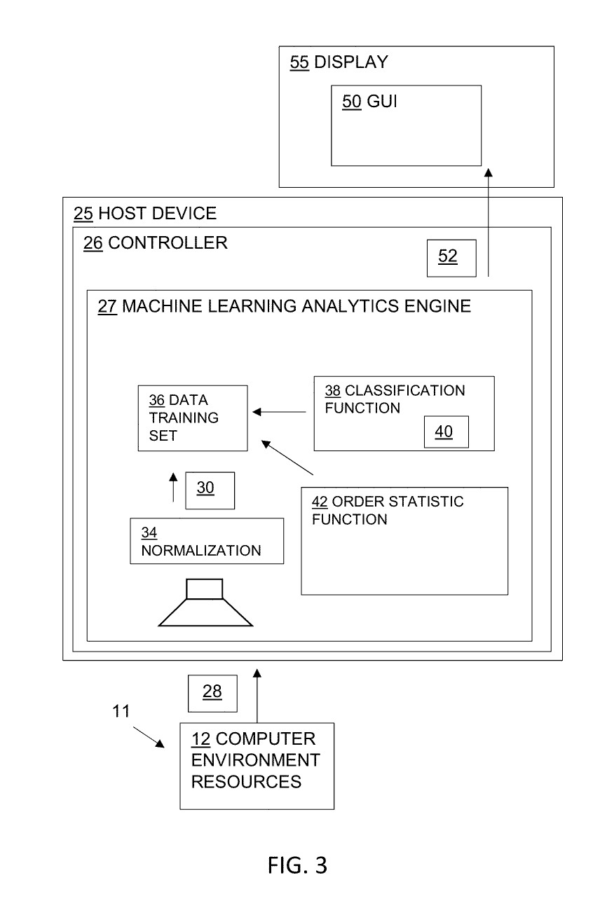

Next, with reference to FIG. 3, the host device 25 is configured to apply an order statistic function 42 to the maximum thresholds 120 for each time interval 110. Anomalousness, is a function of the variability in the data, which is, in turn, reflected in the random variability among the thresholds. Therefore, quantifying the threshold variability will provide a probabilistic framework underlying anomaly detection.

Taking the second time interval 110-2 of FIG. 7 as an example, assume the case where the first maximum threshold 120-2 associated with the first cluster 102-1 of the first set of clusters 102 has a latency value of 10, that the second maximum threshold 120-3 associated with the first cluster 104-1 of the second set of clusters 104 has a latency value of 8, and that a first maximum threshold 120-4 associated with the first cluster of a third set of clusters (not illustrated) has a latency value of 12. When applying the order statistic function 42, the host device 25 can order the thresholds 120 for the time interval 110 from the threshold having the highest value (e.g., threshold 120-4) to the threshold having the lowest value and can later calculate probability values during the process of anomaly detection.

In one arrangement, the host device 25 can estimate or identify the relative variability among the ordered thresholds 120 and can identify probability distributions for the order statistics during the process of anomaly detection.

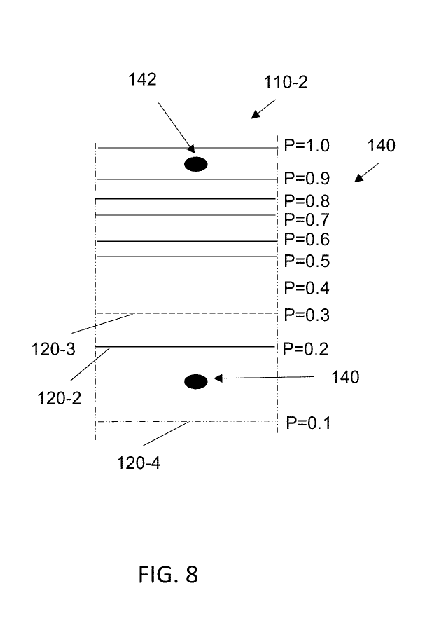

For example, FIG. 8 illustrates an example of application of the order statistic function to the ten maximum thresholds 120 of time interval 110-2 by the host device 25. FIG. 8 also illustrates that following ordering of the maximum thresholds 120, the host device 25 has determined the probability distributions of the resulting order statistics. Based upon the ordered statistics for each time interval 110, the host device 25 is then configured to calculate the probability distributions for the order statistics and to assign the probability values 140 to each of the ordered thresholds accordingly.

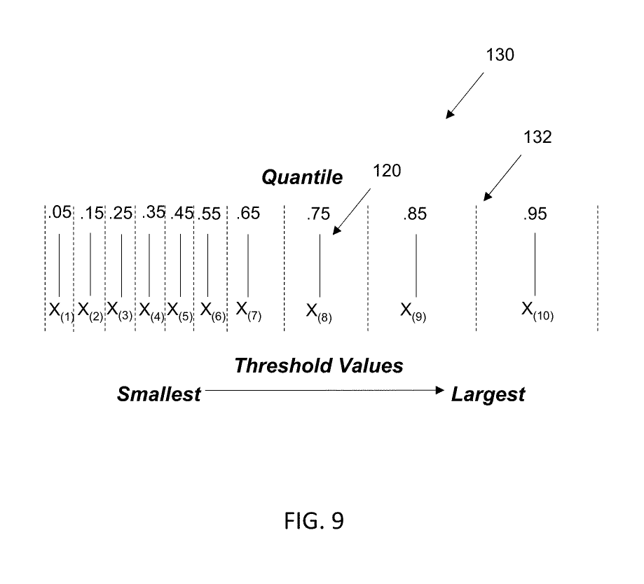

When identifying or calculating the probability distributions, the host device 25 can be configured to leverage quantiles, such as a collection of non-parametric statistics that allow the host device to estimate the relative variability among sample thresholds 120. For example, as shown in FIG. 9, assume the case where 10 the host device 25 identifies ten maximum threshold values 120 for a given time interval 110 (e.g., arising from ten independent applications of the clustering function 40). Further assume the host device 25 applies the order statistic function 42 to the threshold values 120 to order the thresholds from smallest to largest so that they may be treated empirically as quantiles, as illustrated.

As indicated in FIG. 8, the dotted lines 132 represent the quantiles that lie between each observed threshold value (e.g., Q₁, Q₂, etc.), where the first and last of the quantiles 132 se are extrapolated to estimate Q₀ and Q₁, respectively. Based on these quantiles 132, the host device 25 provides:
1.) A randomly generated threshold will fall between x₍ᵢ₎ and x₍ᵢ₊₁₎ with probability 0.1, for i=1, . . . , 9.
2) Relatively wider quantile ranges (e.g., x₉, x₁₀) indicate greater variability in the data/thresholds.
3) Given an observed data point x in real time, its position relative to these quantiles can provide a relative certainty as to the data point being anomalous. For example, if x [∈x₁, x₂], the data point can be considered anomalous according to only 5-15% of randomly generated thresholds. By contrast, x [∈x₉, x₁₀] the data point would exceed 85-95% of thresholds.
4) For x<x 0, virtually no thresholds are exceeded.

Based on (3) and (4) above, the host device 25 can be configured to utilize the quantiles to estimate the probability that a data point was truly anomalous and/or qualifying the severity of the anomaly for the purposes of creating or updating existing issues, as well as aggregate anomaly severities for characterization of issue severity.

By associating a probability value to each of the ordered thresholds, the host device 25 is configured to measure uncertainty with respect to data points located within each time interval 110. It is noted that probability and uncertainty are not necessarily synonymous—uncertainty is a property of a given probability estimate relating to precision, and is dependent upon the amount of data used to compute the probability estimate. However, probability can be interpreted in the following way: “What is the probability that a threshold generated at random by the K means clustering algorithm 40 will identify a data point as an anomaly?” In other words, “How certain is the host device 25 that this point is anomalous?”

In one arrangement, as part of an anomaly detection process, the host device 25 is configured to identify the ordered thresholds 120 and determine, for a particular data point investigated as being anomalous, the number of thresholds that the investigated data point has crossed or exceeded. Once the host device 25 has identified a given threshold, the host device 25 can be configured to divide the highest maximum ordered threshold reached by the total number of thresholds in order to derive the probability that the investigated data point is truly anonymous. Further, the host device 25 can be configured to utilize that derived probability to report the probability of each data point as an anomaly, as well as even control it, by only accepting anomalies with highest probability (such as 0.9).

For example, assume the case where the host device 25 is configured with 90% probability, such that the host device 25 is 90% confident of its outcome. Further assume the case where the host device 25 has identified a data element disposed within a probability distribution of the ordered thresholds. As shown in FIG. 8, a first data element 140 falls within a timeframe having a probability of between 0.1 and 0.2 while a second data element 142 falls within a timeframe having a probability of greater than 0.9. Based on this identification, the host device 25 is configured to identify a probability of the data element being an anomalous data element based upon the relation of the data element to the probability value of an ordered threshold disposed in proximity to the data element. For example, with respect to the uncertainty measurement, the host device 25 can identify the first data element 140 as having a low probability as being an anomaly and can identify the second data element as having a high probability as being an anomaly.

In one arrangement, with reference to FIG. 2, as a result of the classification and detection, the host device 25 can provide an output 52 to a user via a graphical user interface 50 reporting an identified data element as being anomalous. For example, the host device 25 can be configured to provide the output 52 when a given data element has an associated, relatively high probability (such as 0.9) of being anomalous.

With such a configuration, the host device 25 is configured to stabilize the data training set 36 to substantially reflect real data received from the computer infrastructure 11. This configuration of the host device 25 enables the quantification of the uncertainty/variation in the data training set 36. Specifically, the host device 25 is configured stabilize the clustering of a data training set 36 and to allow the measurement of the uncertainty associated with the data training set. As a result, the host device 25 can support probability estimation for various additional components associated with the computer infrastructure 11, such as anomaly detection, root cause selection, and/or issue severity ratings.

As provided above, the host device 25 is configured to develop a data training set 36 for use in anomalous behavior detection. Such description is by way of example only. In one arrangement, the host device 25 is configured to develop the data training set 36 for performance of other functions including, but not limited, to forecasting of the future behaviors and problems in the computer infrastructure 11.

While various embodiments of the innovation have been particularly shown and described, it will be understood by those skilled in the art that various changes in form and details may be made therein without departing from the spirit and scope of the innovation as defined by the appended claims.

What is claimed is:

1. In a host device, a method for stabilizing a data training set, comprising:
generating, by the host device, a data training set based upon a set of data elements received from a computer infrastructure;
applying, by the host device, multiple iterations of a classification function to the data training set to generate a set of data element groups;
dividing, by the host device, the set of data element groups resulting from the multiple iterations of the classification function into multiple time intervals;
for each time interval of the multiple time intervals, deriving, by the host device, a maximum threshold and a minimum threshold for each data element groups of the set of data element groups included in the time interval;
applying, by the host device, an order statistic function to the maximum thresholds and the minimum thresholds for each time interval; and
identifying, by the host device, a relative variability among the ordered maximum thresholds.

2. The method of claim 1, wherein applying multiple iterations of a classification function to the data training set to generate a set of data element groups comprises applying, by the host device, multiple iterations of a clustering function to the data training set to generate a set of clusters.

3. The method of claim 2, wherein dividing the set of clusters resulting from the multiple iterations of the clustering function into multiple time intervals comprises:
detecting, by the host device, a first time edge associated with a cluster of the set of clusters;
assigning, by the host device, the first time edge a first time interval boundary;
detecting, by the host device, a second time edge associated with a cluster of the set of clusters; and
assigning, by the host device, the second time edge a second time interval boundary, the first time interval boundary and the second time interval boundary defining a first time interval of the multiple time intervals.

4. The method of claim 1, wherein applying the order statistic function to the maximum thresholds and the minimum thresholds for each time interval further comprises:
identifying, by the host device, probability distributions for the ordered thresholds; and
assigning, by the host device, a probability value to each of the ordered thresholds.

5. The method of claim 4, further comprising:
identifying, by the host device, a data element disposed within a probability distribution of the ordered thresholds;
identifying, by the host device, a probability of the data element being an anomalous data element based upon the relation of the data element to the probability value of an ordered threshold disposed in proximity to the data element.

6. A host device, comprising:
a controller having a memory and a processor, the controller configured to:
generate a data training set based upon a set of data elements received from a computer infrastructure;
apply multiple iterations of a classification function to the data training set to generate a set of data element groups;
divide the set of data element groups resulting from the multiple iterations of the classification function into multiple time intervals;
for each time interval of the multiple time intervals, derive a maximum threshold and a minimum threshold for each data element groups of the set of data element groups included in the time interval;
apply an order statistic function to the maximum thresholds and the minimum thresholds for each time interval; and
identify a relative variability among the ordered maximum thresholds.

7. The host device of claim 6, wherein when applying multiple iterations of a classification function to the data training set to generate a set of data element groups the controller is configured to apply multiple iterations of a clustering function to the data training set to generate a set of clusters.

8. The host device of claim 7, wherein when dividing the set of clusters resulting from the multiple iterations of the clustering function into multiple time intervals, the host device is configured to:
detect a first time edge associated with a cluster of the set of clusters;
assign the first time edge a first time interval boundary;
detect a second time edge associated with a cluster of the set of clusters; and
assign the second time edge a second time interval boundary, the first time interval boundary and the second time interval boundary defining a first time interval of the multiple time intervals.

9. The host device of claim 6, wherein when applying the order statistic function to the maximum thresholds and the minimum thresholds for each time interval, the controller is further configured to:
identify probability distributions for the ordered thresholds; and
assign a probability value to each of the ordered thresholds.

10. The host device of claim 9, wherein the controller is further configured to:
identify a data element disposed within a probability distribution of the ordered thresholds;
identify a probability of the data element being an anomalous data element based upon the relation of the data element to the probability value of an ordered threshold disposed in proximity to the data element.

11. A computer program product encoded with instructions that, when executed by a controller of a host device, causes the controller to:
generate a data training set based upon a set of data elements received from a computer infrastructure;
apply multiple iterations of a classification function to the data training set to generate a set of data element groups;
divide the set of data element groups resulting from the multiple iterations of the classification function into multiple time intervals;
for each time interval of the multiple time intervals, derive a maximum threshold and a minimum threshold for each data element groups of the set of data element groups included in the time interval;
apply an order statistic function to the maximum thresholds and the minimum thresholds for each time interval; and
identify a relative variability among the ordered maximum thresholds.
